(19) United States
(12) Patent Application Publication
(10) Pub. No.: US 2011/0309170 A1
(43) Pub. Date: Dec. 22, 2011

(54) Free Flow Spreader Device

(76) Inventor: Christopher Weeks, Beaverton, AL (US)

(21) Appl. No.: 13/165,104

(22) Filed: Jun. 21, 2011

Related U.S. Application Data
(60) Provisional application No. 61/357,118, filed on Jun. 22, 2010.

(51) Int. Cl. A01C 23/00; A01C 3/06; A01C 19/00; A01C 17/00

(52) U.S. Cl. 239/661; 239/668

(57) ABSTRACT

Disclosed is an improved means for spreading solid or liquid agricultural products, ideally suited for use with a tractor or similar vehicle with an external power takeoff shaft. For solid agricultural products, a specially designed hopper is used in conjunction with a cone-shaped, flow control stopper and an outlet agitator for providing a uniform delivery of product onto a rotating impeller. A plurality of gearboxes provide motive distribution of power for the hopper outlet agitation and impeller, while a user-accessible handle controls the control stopper height within the hopper outlet, and thus controlling the flow rate from the hopper. For liquid products, a cylindrical hopper is provided, along with a pump and a plurality of hoses for drawing or recycling the liquid product. A rear-mounted spray rail is provided for dispensing the liquid product, while an accessory connection is provided for a user to manually distribute the product with an attachable spray gun device.

### CROSS REFERENCE TO RELATED APPLICATION

This application claims the benefit of U.S. Provisional Application No. 61/357,118 filed on Jun. 22, 2010, entitled “Free Flow Spreader.”

### BACKGROUND OF THE INVENTION

1. Field of the Invention

The present invention relates to tractor-driven, agricultural material spreader devices. More specifically, the present invention pertains to devices for spreading liquid or solid material, and an improved means of evenly dispensing and broadcasting the same.

2. Description of the Prior Art

Agricultural and lawn care spreaders are well described in the art. These devices provide a means for distributing liquid, solid or moistened material as they are operated, in either a broadcast, drop or spray manner. The size and sophistication of these devices are dependent upon intended application and intended coverage area. The means for distribution, means for motive power and intended product are likewise diverse. Typical spreaders range from small, personal spreaders for small lawns and properties, to industrial sized or tractor-driven assemblies for spreading products over large agricultural and commercial areas. The present invention contemplates an improvement in material communication from a hopper to a spreading means, and one that can be utilized on any sized spreader.

Spreaders used for the distribution of various agricultural or lawn care products over a given area. They eliminate the need for a user to manually spread the material, which is time consuming, difficult to spread evenly and even harmful depending upon the specific material being spread. These devices have familiar design elements and features, most notably being a spreading means in the form of a rotating impeller, a hopper for containing the material, a hopper outlet control and a means for rotating the impeller. The present invention provides an improved hopper design in which its shape is similar to a curved funnel or balloon shape, and its construction comprises a soft, non-stick material for improved material communication and collection at the base of the hopper. The hopper outlet is connected to an agitator, which vibrates the outlet during operation to ensure even flow of material, without clumping or voids. The agitation allows the material to further settle to the base of the hopper interior prior to exiting onto an impeller for distribution thereof. Controlling the flow of material from the hopper outlet is a cone-shaped stopper, which allows material to fall about its upper surface as it disengages the outlet for even dispensation onto the impeller surface. The material is gravity fed, while it maintains a compact consistency from the agitation and shape of the hopper.

Spreaders commonly used in the art share common drawbacks that limit their usefulness and cause problems during operation. Most notably, these spreaders do not provide even spreading of material during operation, as clumps and void develop in material contained in the hopper. This leads to a non-uniform distribution of flow from the hopper outlet to an impeller or similar spreading means. Further, the flow control of many of the devices in the art is a sliding trap door or openable aperture and metering plate. As the door or plate is moved to reveal the opening, material instantly flows from the opening at a specific location on the spreader. This leads to a condition wherein the spreader is receiving a bulk inflow of material or material at a non-uniform rate. The result is uneven distribution or dispensation of too much material in one area. This can lead to losses in material, money and possibly damage to the agriculture in the affected location. A solution to these common drawbacks is required, one that ensures uniform flow and dispensation of material from a hopper and dispensing means, and one that is easy to operate and maintain.

Patents have been published in the art for typical spreader devices that are subject to the aforementioned drawbacks. These include U.S. Pat. No. 4,798,325 to Block describes a manually driven spreader means for use with dry or wet lawn care products. The products are dispensed and broadcast from a hopper device, wherein material is gravity fed onto a spreading means powered by the manual propulsion of the overall device by the user. An electrically powered pump means provided motive force to dispense liquid product, along with valve operated spray nozzles or a hand carried spray wand that is attached to the hopper. While this device is useful for spreading lawn care products that are both liquid or solid, it's power is derived by motion of its wheels, and therefore is not operational when stationary. Also, it's hopper design does not provide the equal distribution of product onto the distribution means prior to spreading, as provided by the specifically designed hopper, flow control cone and outlet agitator of the present invention.

U.S. Pat. No. 6,945,481 to Thompson describes another push cart spreader with a first and second discharge opening within a hopper of material. The cart is designed to accommodate both broadcast spreading and drop spreading of material. An impeller below the hopper provides a means to distribute the material in a broadcast fashion. Its rotation is derived by motion of the wheels, similar in to the Block patent. This patent is similar in design and structure to the Block patent, and similarly fails to disclose the elements of the present invention. It similarly suffers from a drawback common in the art, namely an efficient and even means of material communication from the hopper to the impeller surface, along with a hopper design that prevents clumping, blockages and voids. This patent also does not accommodate the spreading of liquid material.

U.S. Pat. No. 6,637,678 to Wyne describes a granular material spreader for a mower or other apparatus, comprising a hopper with a plurality of apertures and a control plate pivotably mounted to the underside of the hopper. When pivoted, the control plate provides full or partial opening of the flow apertures for dispensing the granular material from within the hopper to an impeller device for distribution thereof. This device controls the flow of material via a pivoting plate, which is a variation on traditional dispensing hoppers which utilizing a sliding trap door to gravity dispense material within the hopper. These devices lead to uneven dispensation of the material onto the distribution means, and uneven distribution of material thereof onto an intended lawn or farm ground surface. The present invention provides a cone control means that enters or exits the hopper outlet by control of the user. The cone shape provides 360 degree, even distribution to the impeller below and therefore even dispensation of material from the device. The shape of the hopper in the present invention is also designed to eliminate clumping, blockages and voids that are common with a standard hopper.

U.S. Pat. No. 6,499,679 to Woodruff describes a method and apparatus for dispensing granular agricultural material from a push driven cart. The material is gravity fed from a hopper to an impeller through an apertured metering disk. The impeller is driven by the linear speed of the apparatus for uniform distribution of material therefrom. Similar to the aforementioned patents, the Woodruff patent does not provide a means to prevent clumping or uneven distribution onto the impeller. It is also push driven, which limits the amount of material being hauled in the hopper, as well as limits the rotation of the impeller to the rotation of the wheels. This does not allow for uniform distribution from the hopper or uniform broadcast from the impeller.

The present invention improves on the devices in the art and those currently in the market by providing improved communication from the hopper, evenly distributing the material onto an impeller device and evenly broadcasting the same from the rear of the device. The hopper, cone-shaped stopper and agitator are unique features that are particular advances in the art. The means contemplated for providing power to the device include rotary action as the device is pushed manually by a user, providing power from an ATV or lawn more device, or likewise from the Power Take Off (PTO) shaft of a tractor or vehicle towing the present invention. The elements of the present invention are sufficiently distinguished and substantially diverge from those devices in the art. Consequently it is clear that there is a need in the art for an improvement to existing material spreader devices. In this regard the instant invention substantially fulfills these needs.

### SUMMARY OF THE INVENTION

In view of the foregoing disadvantages inherent in the known types of material spreader devices now present in the prior art, the present invention provides a new spreader device wherein the same can be utilized for providing convenience for the user when uniformly dispensing and broadcasting granular, moist or liquid material.

The present invention provides a solution to many common drawbacks associated with spreader devices, particularly with regard to uniform distribution, complete dispensation of hopper contents and the ability to accommodate solid, moist or liquid material. The device efficiently eliminates voids that form in the typical hoppers, which is common when spreading moist or viscous material. The present invention further employs a balloon shaped hopper that contains the material to be spread. The shape and elasticity of this container further prevents clumping or voids from forming and allows for a continuous, free flow of the material through the hopper chute in a gravity feed process aided by an agitator. A arm assembly located below the chute provides the oscillatory agitation thereof to compact and condense material at the base of the hopper for even dispensation and flow of material through the hopper chute. Finally, the hopper outlet stopper is cone shaped, providing even distribution onto a spinning impeller device for broadcast distribution. The standard door type discharge mechanism is replaced in favor of a cone shaped stopper, which is user controlled to increase or decrease the flow rate from the hopper.

It is therefore an object of the present invention to provide a new and improved material spreader device that has all of the advantages of the prior art and none of the disadvantages.

It is therefore an object of the present invention to provide a new spreader device that provides the user a means for uniformly dispensing material from a hopper using a specifically designed hopper, an agitator attached to the hopper chute and a cone-shaped stopper for evenly gravity feeding material onto an impeller device for dispensation thereof.

Another object of the present invention is to provide a hopper design that incorporates a balloon shape that tapers in a curved fashion from the hopper fill to the hopper chute. The hopper is likewise comprised of an elastic, non-slip material to prevent clinging or voids of material, and for improved settling of material at the hopper chute.

Another object of the present invention is to provide an agitator means for shaking or vibrating the hopper chute for even settling of material at the base of the hopper, and for uniform flow therefrom.

Another object of the present invention is to provide a cone-shaped stopper device that engages the hopper chute. As the stopper withdraws from the chute, its coned shape allows material flow along its external surface in all radial directions, eliminating uneven placement of material on the impeller surface during operation.

Another object of the present invention is to provide a device that utilizes a plurality of gearboxes to distribute rotary or linear displacement of the disclosed mechanisms, most notably the rotation of the impeller device and the agitation means.

Another object of the present invention is to provide the user with control of the cone-shaped hopper, allowing said user to increase or decrease the flow rate from the hopper chute as desired.

Yet another object of the present invention is to provide a device that may utilize any number of means for motive power, including manual push cart devices that utilize the rotation of the device's wheels to power a plurality of gearboxes, or conversely providing a frame and input shaft for attachment to a tractor and PTO thereof. Likewise, the device may be incorporated into dedicated spreader vehicle, using the presented components to evenly spread material. The device may also be used with an All Terrain Vehicle (ATV) or lawn mower if so desired.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the preferred embodiment of the present invention, utilizing a tractor pull frame and PTO drive shaft.

FIG. 2 shows a side perspective view of the preferred embodiment of the present invention.

FIG. 3 shows a close-up perspective view of the hopper chute, agitator arm and cone-shaped stopper.

FIG. 4 shows an alternate embodiment of the present invention, wherein a liquid material spreader is provided.

### DETAILED DESCRIPTION OF THE INVENTION

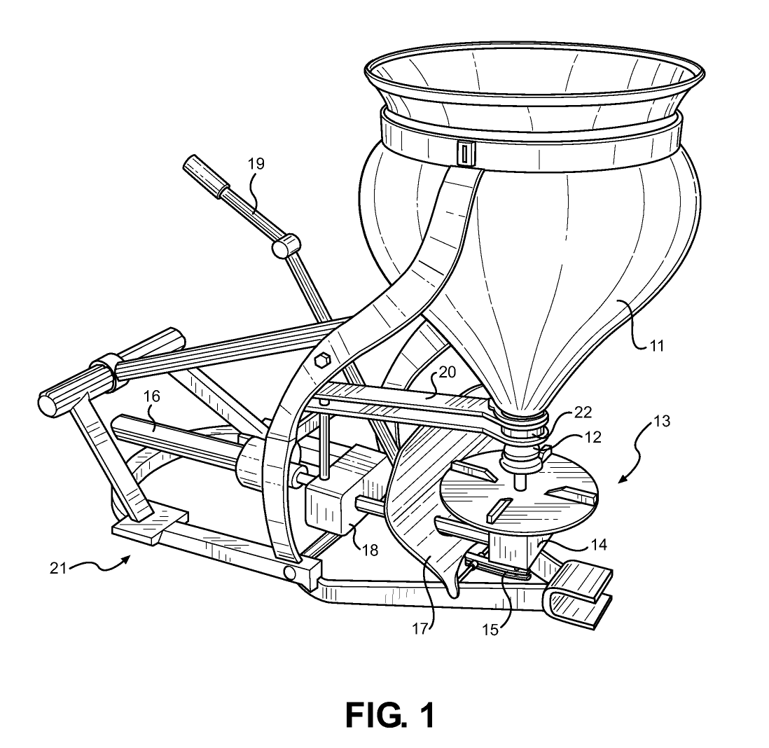

Referring now to FIG. 1, there is shown a perspective view of the preferred embodiment of the present invention. A balloon shaped hopper 11 attaches to a tractor pull frame 21. The base of the hopper terminates at a chute 22, while its upper includes an opening for filling its interior with material intended for spreading. The hopper 11 includes a curved taper that promotes improved gravity feeding of material through its chute 22 with reduced tendency of material to adhere or stick along its inner surface. A cone-shaped stopper 12 controls flow of material through the chute, as its vertical positioning is controlled by the user via a control handle 19. The stopper 12 can completely shut off the flow of material from the hopper 11 or modify its flow rate, depending upon its positioning relative to the chute 22. The control handle 19 connects to a positioning arm 15 below the impeller 13 for direct control of the stopper 22 position.

A rotating impeller device 13 provides a surface for the gravity fed material to land upon, while vertical impeller blades support the material and allow it to flow radially outward for broadcast distribution. A containment plate 17 prevents the material from being spread in a forward direction, as material is deflected upon impact. The shape of the stopper allows the material to be equally distributed onto the impeller 13 surface from the chute 22, as opposed to non-uniform clumps or biasing to one side of the chute 22 over another, as is typical with door-type chute control.

The base of the hopper 11 and the chute 22 is provided an oscillatory vibration to settle material in the hopper and improve uniformity of flow. An agitator arm 20 connects to the chute 22 to provide a means of transferring vibration from a first gearbox 18. The arm 20 vibrates back and forth to compact the material, preventing voids or clumping, particularly when operating with moist or viscous material. A second gearbox 14 provides rotational input for the impeller device 13, which spins to spread the material radially outward from the device. Power to the gearboxes in this particular embodiment is provided by a driveshaft 16, which is connected to a tractor PTO for rotational power input.

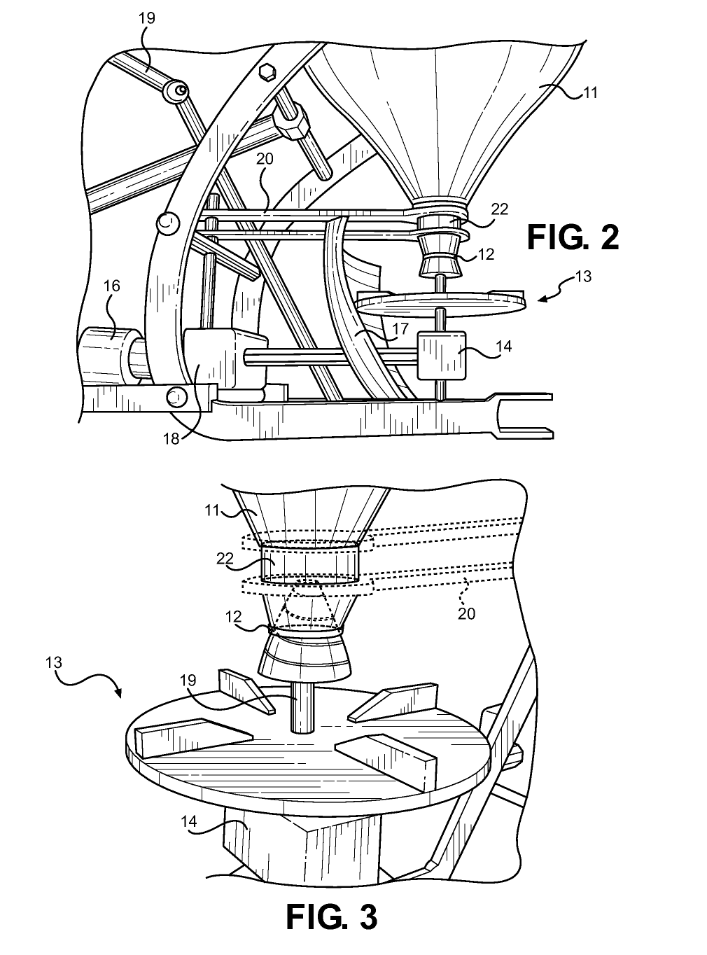

Referring now to FIG. 2, there is shown a side perspective view of the preferred embodiment of the present invention. The hopper 11 terminates at a chute 22, which connects to an agitator arm 22 for support and vibratory input therefor. The chute 22, and likewise material communication therethrough, is controlled by a cone-shaped stopper 12, which regulates the flow and also evenly dispenses material onto the impeller 13 below. A PTO drive shaft provides input for a first 18 and second gearbox 14 that provides input to the agitator 20 and the impeller rotation 13, respectively. Vertical positioning of the stopper 12 is controlled by a linkage 19 provided to the user and accessible during operation.

Referring now to FIG. 3, there is shown a close-up perspective view of the operation of the cone-shaped stopper 12 in connection to the hopper 11 and chute termination 22. As the stopper 12 is removed from the chute 22, material begins to flow due to gravity, and flows equally along the outer surface of the stopper 12 cone shape for uniform dispensation onto the impeller 13 stationed therebelow. A linkage arm 19 provides input control for the positioning of the stopper 12 within the chute 22. An oscillating agitator arm 20 vibrates the chute 22 to ensure even flow and settling of material within the hopper 11. The design of the cone-shaped stopper vastly improves the dispensation of material onto the spinning impeller 13, as equal material is placed radially along the plate for even spreading thereof.

The frame and motive input for the preferred embodiment is not desired to be limiting. Conversely, these elements may take any form desired by one skilled in the art of tractor devices or spreader devices. In place of the frame, the elements of the hopper, stopper, and agitator may be placed on a push-cart embodiment, which provides input through rotation of the cart wheels as opposed to a PTO drive shaft. The frame may likewise be modified if a tractor pull version is desired. A final embodiment contemplates incorporation of the present invention onto a dedicated spreader vehicle. The structure and sophistication with regard to these embodiments is dependent upon end user requirements and needs.

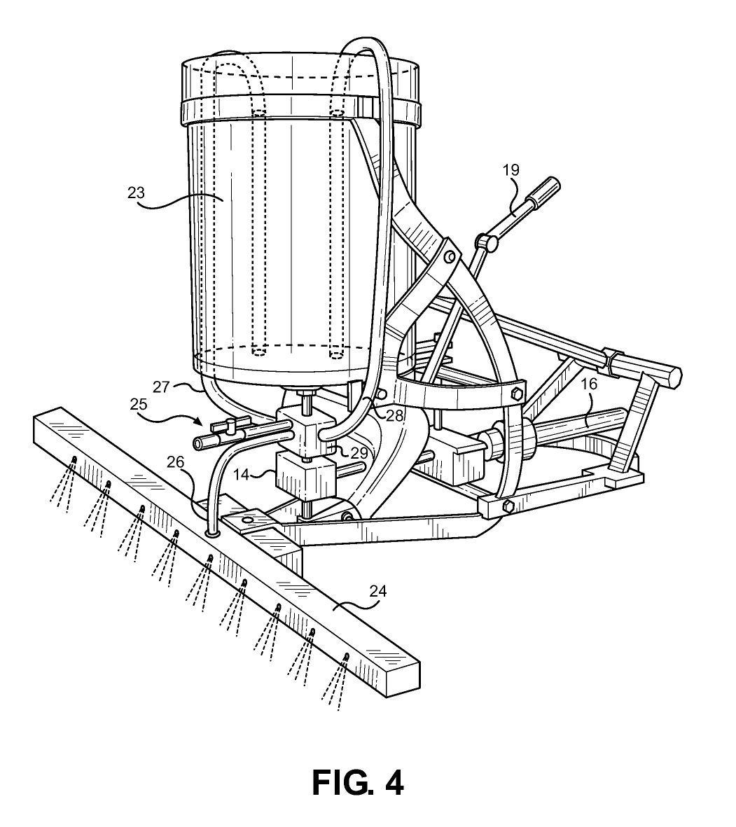

Referring now to FIG. 4, there is shown an alternate embodiment of the present invention, wherein a liquid material spreader is provided. The balloon shaped hopper is replaced with a cylindrical hopper 23. A first draw tube 27 is provided for suctioning liquid from the inner volume of the hopper 23, routing it through a distributing hose 26 to a spray rail 24 device. The spray rail 24 comprises an elongated rail with a plurality of spray nozzles or apertures for downwardly spreading liquid material from the hopper 23. A pump 29, powered by a first gearbox 14, provides the pressure required to draw the liquid from the hopper 23 through the draw tube 27. A second feed tube 28 is provided to recycle the liquid material back into the hopper 23 when the spray rail 24 is deactivated, allowing continual use of the pump 29 and independent control of the spray rail 24. A secondary dispensing hose 25 is provided with a valve for hook-up to a handheld, user operated personal sprayer gun. In this mode, the user attaches a manual spray gun to the secondary dispensing hose 25 to manually spread the liquid material from the hopper 23. The flow rate from the hopper 23 is controlled via a handle linkage 19 provided to the user, allowing more or less fluid material to be dispensed per given period of time. The draw 27 and feed 27 tubes may also be attached to the base of the hopper 23 if desired for improved drainage and recycling. A PTO drive shaft is also provided in this embodiment for driving the pump 28. Similar to the preferred embodiment, alternate means for powering the pump are considered, including a hand driven cart and a dedicated vehicle utilizing the spray rail and hopper design.

The present invention is utilized to improve the current devices used to spread material for agricultural and lawn care needs. The material may consist of any agricultural product, including but not limited to fertilizers, pesticides, water, lime and salts. It is not desired to limit the chosen material, but to offer a device that is capable of spreading any type of fine or granulated material, moistened material or liquid. The design of the preferred embodiment hopper, for use with solid or granulated material, is shaped to improve the gravity feed process, while the agitator allows settling and reduces voids. The shape also prevents clumping or clinging to the inner walls of the hopper. Its material is ideally an elastic polymer or similarly elastic material, and one that provides a smooth, nonstick surface to further prevent clinging. The elasticity allows the hopper to oscillate appropriately without the brittleness of a harder material, which is of particular importance in the presence of the agitator. An elastic chute improves the agitator's capacity to settle the material, as the hopper is pliable and easily moves with the agitator during operation.

In use, an individual may spread material with improved uniformity and without risk of wasted or overly applied material to a given area. The user may utilize the elements of the device in a tractor driven configuration, or choose a less sophisticated embodiment which derives power from manually driven push cart wheels. The novelty of the present invention is derived from the hopper design, chute agitator, cone-shaped spreader and their application on a modular design that can further support a liquid spreader configuration. In light of the given disclosure and review of the similar prior art devices, the present invention provides an improved spreader device that advances the art and fulfills a long felt need.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A spreader device for uniformly dispensing and spreading material, comprising:
a hopper for storing material with sidewalls, an open upper termination and a chute lower termination;
said upper termination being of larger area than said chute lower termination, and said sidewalls contouring from said upper to said chute in a balloon shape to enhance feeding said material through said chute;
an agitator means coupled to said chute, said agitator providing oscillatory vibration to said chute;
a cone shaped stopper formed to engage said chute and prevent material leakage therefrom when engaged and uniformly dispense material below when disengaged;
a rotating impeller device below said stopper;
a plurality of gearboxes to drive said agitator means and said impeller;
a control linkage for controlling said stopper vertical position and engagement of said chute.

2) A device as in claim 1, further comprising a containment shield to prevent spread of material onto said spreader device.

3) A device as in claim 1, further comprising a tractor tow frame support and a PTO drive shaft for powering said gearboxes.

4) A device as in claim 1, further comprising push cart frame, a plurality of wheels and a means for transforming power from said wheels to an input for said gearboxes.

5) A device as in claim 1, wherein said hopper is comprised of an elastic, polymer material and a smooth surface finish to reduce clinging and clumping of material within its inner volume.

6) A spreader device for uniformly dispensing and spreading material, comprising:
a balloon shaped hopper for storing material with sidewalls, an open upper termination and a chute lower termination;
said upper termination being of larger area than said chute lower termination, and said sidewalls contouring from said upper to said chute in a balloon shape to enhance feeding said material through said chute;
an agitator means coupled to said chute, said agitator providing oscillatory vibration to said chute;
a cone shaped stopper formed to engage said chute and prevent material leakage therefrom when engaged and uniformly dispense material below when disengaged.

7) A spreader device for uniformly dispensing and spreading liquid material, comprising:
a hopper for storing material with sidewalls, an open upper termination and closed lower termination;
a pump connected to a draw hose for drawing liquid from said hopper and a fill hose for recycling liquid back into said hopper,
a spray rail device comprising a plurality of nozzles and connected to said pump via a distribution hose;
a secondary hose for attachment of a personal water dispenser gun.

8) A device as in claim 7, further a control linkage for controlling the flow rate from said hopper and through said spray rail nozzles.

9) A device as in claim 7, further comprising a tractor tow frame support and a PTO drive shaft for powering said pump via a gearbox.

10) A device as in claim 7, further comprising push cart frame, a plurality of wheels and a means for transforming power from said wheels to an input for said pump.

11) A device as in claim 7, wherein said hopper is cylindrical in shape.

12) A device as in claim 7, wherein said hopper is comprised of an elastic, polymer material and a smooth surface finish.
